(19) United States
(12) Patent Application Publication
(10) Pub. No.: US 2008/0019506 A1
(43) Pub. Date: Jan. 24, 2008

(54) Encryption/Decryption Apparatus, System and Method

(76) Inventor: Yung-Huan Hsu, Hsinchu City (TW)

Correspondence Address: LAW OFFICES OF LAI & ASSOCIATES, P.C., STE 200, 5800 RANCHESTER, HOUSTON, TX, 77036, US

(21) Appl. No.: 11/459,300

(22) Filed: Jul. 21, 2006

(51) Int. Cl. H04L 9/28

(52) U.S. Cl. 380/28

(57) ABSTRACT

A memory encryption/decryption apparatus includes a memory module, an encryption/decryption key and an encryption/decryption unit. The encryption/decryption unit uses the encryption/decryption key to decrypt encrypted input information received by the memory encryption/decryption apparatus and to encrypt output information in the memory module.

### FIELD OF THE INVENTION

The present invention generally relates to memory encryption/decryption apparatus, system and method, and more particularly to an apparatus, a system and a method for preventing the content of a memory to be known by others from a signal transmitted through an external memory interface.

### BACKGROUND OF THE INVENTION

In a traditional method of protecting a memory data, the data written into a memory is encrypted by an encryption hardware circuit and then stored into the memory. If the data is read, a key will be used for reading the encrypted data from the memory. Referring to FIG. 1 for a block diagram of a prior art memory protection apparatus, an encryption/decryption unit 13 encrypts 141 a data to an encrypted input information 161 by an encryption/decryption key 14, if the external device 12 writes input information 151 into a memory module 11; the encryption/decryption unit 13 decrypts 141 the encrypted output information 162 by the encryption/decryption key 14, if the external device 12 reads output information 152, so as to prevent unauthorized access of the content of this memory. However, this prior art has a shortcoming that the content of memory can be known or obtained by the signal of the external memory interface.

To overcome the foregoing shortcomings of the prior art and avoid the data of the external memory interface from being accessed without authorization, the inventor of the present invention based on years of experience in the related field to conduct extensive researches and experiments, and finally invented memory encryption/decryption apparatus, system and method in accordance with the present invention.

### SUMMARY OF THE INVENTION

The primary objective of the present invention is to provide a memory encryption/decryption apparatus, and more particularly to an apparatus, a system and a method for preventing the content of a memory from being accessed or obtained from a signal transmitted through an external memory interface.

To achieve the foregoing objective, the memory encryption/decryption apparatus of the invention comprises a memory module, an encryption/decryption key and an encryption/decryption unit. The encryption/decryption unit uses an encryption/decryption key to decrypt encrypted input information received by the memory encryption/decryption apparatus and encrypt output information of the memory module.

According to the memory encryption/decryption apparatus, system and method of the invention, the memory inputs an encryption/decryption key, and the encryption/decryption unit uses the encryption/decryption key to perform encryption and decryption. When data is written into this memory later, the key is used for encrypting a write command and input information. After the encrypted information is sent to this memory and encrypted by the encryption/decryption unit and the data is determined as read data, the data is stored into the memory. If it is necessary to read the data in the memory, the data at a specific memory address is encrypted before outputting the data, after the encrypted read command and memory address are sent to the memory, and the encryption/decryption unit determines a read command after the decryption is completed, so as to prevent unauthorized access of the data stored in the memory.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a block diagram of a prior art memory protection apparatus;

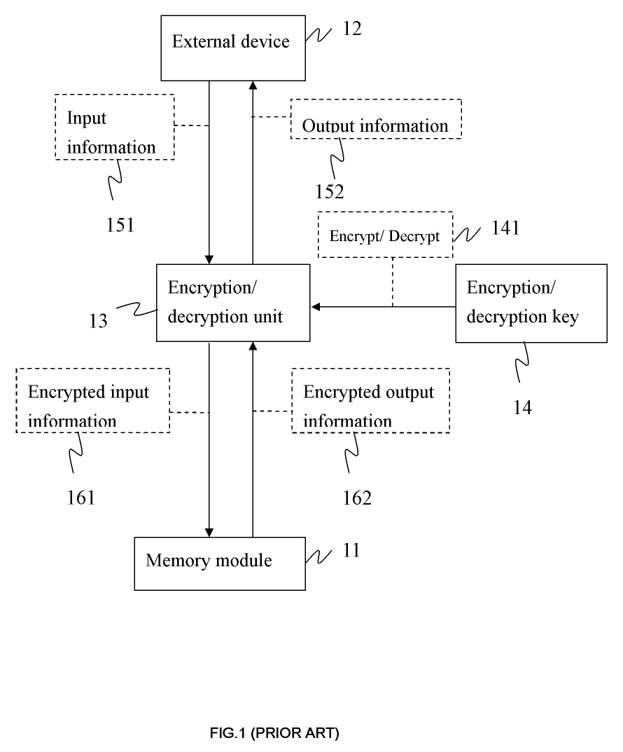

FIG. 2 is a block diagram of a memory encryption/decryption apparatus of the present invention;

FIG. 3 is a block diagram of a memory encryption/decryption system of the present invention;

FIG. 4 is a block diagram of a memory inputting data according to a preferred embodiment of the present invention;

FIG. 5 is a block diagram of a memory outputting information according to a preferred embodiment of the present invention; and

FIG. 6 is a flow chart of a memory encryption/decryption method of the present invention.

### DETAILED DESCRIPTION OF THE PREFERRED EMBODIMENTS

In the related figures of a preferred embodiment, the same referring numerals are used for the same components of in accordance with the present invention.

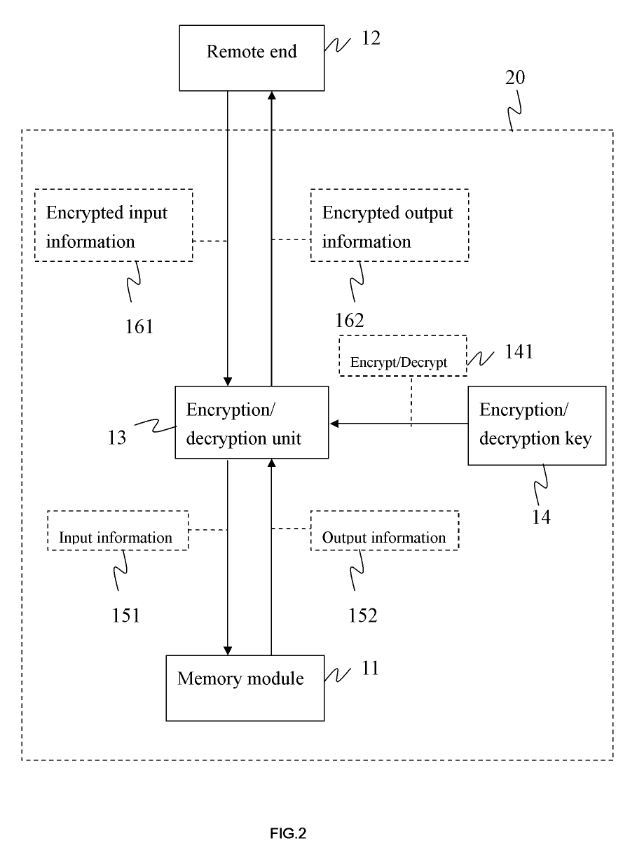

Referring to FIG. 2 for a block diagram of a memory encryption/decryption apparatus of the invention, the apparatus comprises an encryption/decryption key 14, a memory module 11 and an encryption/decryption unit 13. The encryption/decryption unit 13 decrypts 141 the encrypted input information 161 received by the memory encryption/decryption apparatus 20 by using the encryption/decryption key 14 to produce input information 151, and encrypts 141 output information 152 of the memory module 11 to produce encrypted output information 162.

The encrypted input information includes the memory addresses of a write command of the memory module, a writing data, a read command of the memory module and a read data, and the output information is a read data of the memory module, and the memory module is preferably an electrically erasable programmable read only memory (EEPROM) or a flash memory.

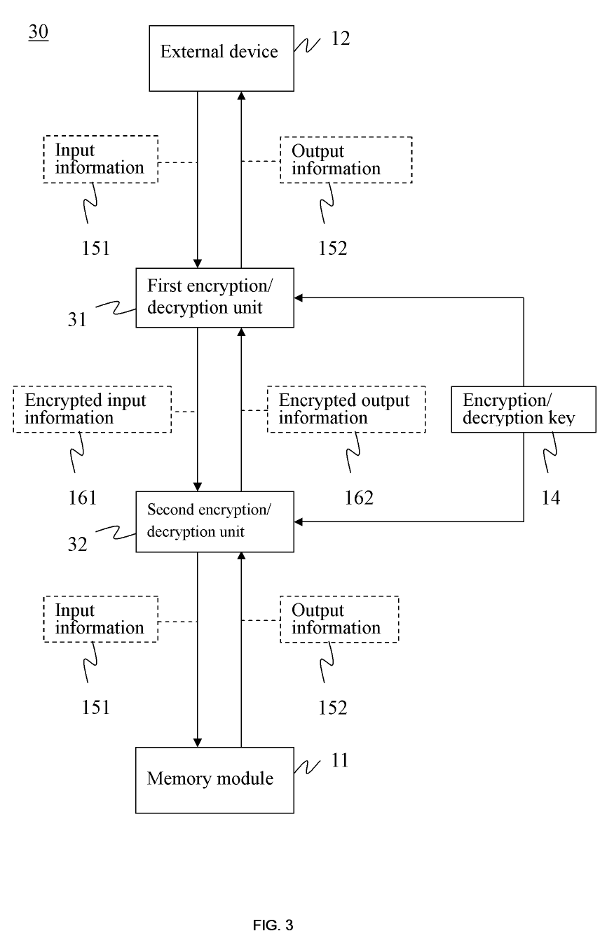

Referring to FIG. 3 for a block diagram of a memory encryption/decryption system of the present invention, the memory encryption/decryption system 30 comprises a memory module 11, an external device 12, an encryption/decryption key 14, a first encryption/decryption unit 31 and a second encryption/decryption unit 32. The first encryption/decryption unit 31 is installed at the external device 12 for encrypting input information 151 sent from the external device 12 to the memory module 11 by using the encryption/decryption key 14 to produce encrypted input information 161, and decrypting encrypted output information 162 sent from the memory module 11 to the external device 12 to produce output information 152.

The second encryption/decryption unit 32 is installed at the memory module 11, for encrypting output information 152 sent from the memory module 11 to the external device 12 by using the encryption/decryption key 14 to produce encrypted output information 162, and decrypting encrypted input information 161 sent from the external device 12 to the memory module 11 to produce input information 151. The input information 151 and output information 152 are stored in the memory module 11.

The input information include the memory addresses of a write command of the memory module, a writing data, a read command of the memory module and a reading data, and the output information is a read data of the memory module, and the memory module is preferably an electrically erasable programmable read only memory (EEPROM) or a flash memory.

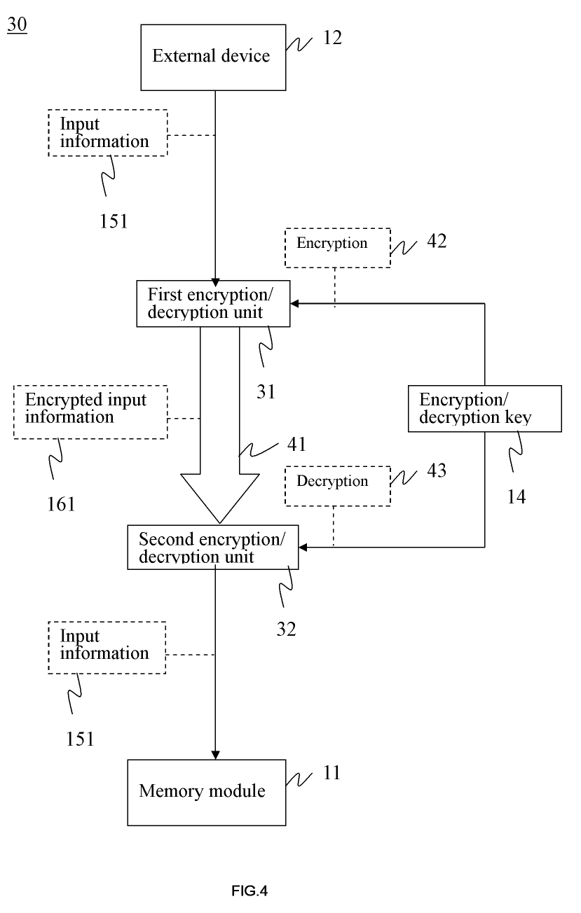

Referring to FIG. 4 for a block diagram of a memory inputting data according to a preferred embodiment of the present invention, an external device 12 of the memory encryption/decryption system 30 encrypts 42 unencrypted input information 151 by the encryption/decryption key 14 of the first encryption/decryption unit 31 to produce encrypted input information 161, and then the encrypted input information 161 is transmitted by the external memory interface 41. The second encryption/decryption unit 32 decrypts 343 the information back to the original input information 151 by the encryption/decryption key 14 and the input information 151 is sent and saved into the memory module 11.

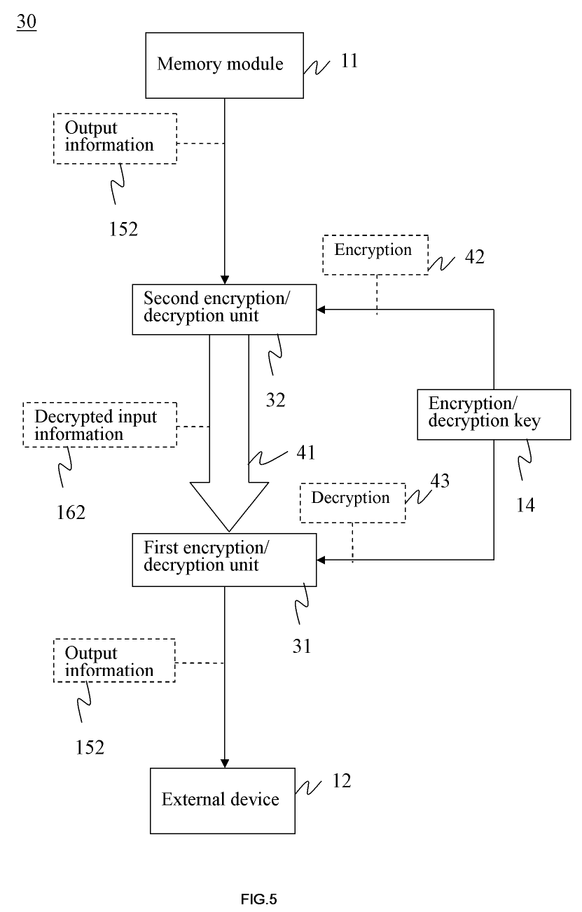

Referring to FIG. 5 for a block diagram of a memory outputting information according to a preferred embodiment of the present invention, a memory module 11 in the memory encryption/decryption system 30 encrypts 42 output information 152 by the encryption/decryption key 14 through the second encryption/decryption unit 32 to produce encrypted output information 162, and then the external memory interface 41 transmits the encrypted output information 162, and the first encryption/decryption unit 31 decrypts 17 the information back to the original output information 152 by the encryption/decryption key 14, and sends the output information 152 to the external device 12.

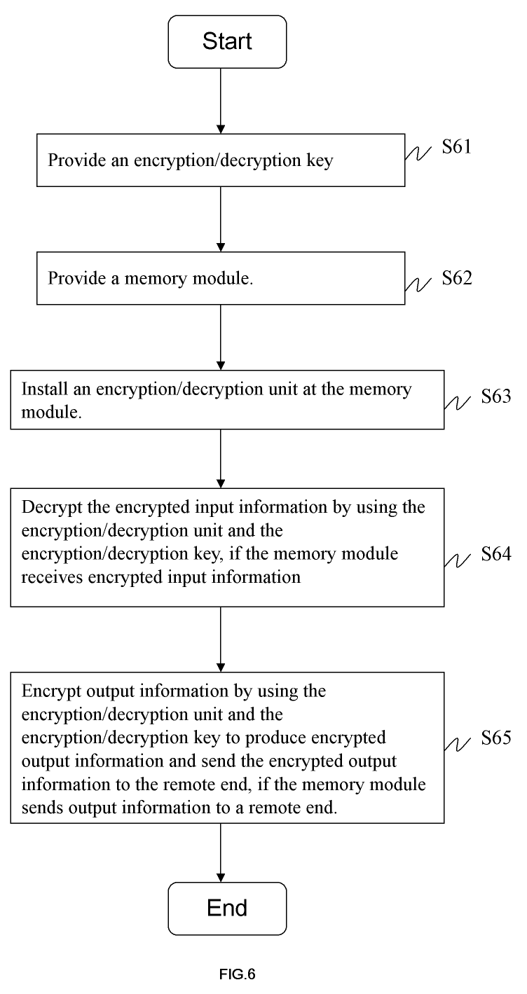

Referring to FIG. 6 for a flow chart of a memory encryption/decryption method of the present invention, the method comprises the steps of:

(Step S61) providing an encryption/decryption key;

(Step S62) providing a memory module;

(Step S63) installing an encryption/decryption unit at the memory module;

(Step S64) decrypting encrypted input information by the encryption/decryption unit and the encryption/decryption key, if the memory module receives encrypted input information; and

(Step S65) encrypting output information by the encryption/decryption unit and the encryption/decryption key to produce encrypted output information and send the encrypted output information to a remote end, if the memory module sends output information to the remote end.

The encrypted input information include the memory addresses of a write command of the memory module, a writing data, a read command of the memory module, a reading data, and the output information is a read data of the memory module, and the memory module is preferably an electrically erasable programmable read only memory or a flash memory.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory encryption/decryption apparatus, comprising:
an encryption/decryption key;
a memory module; and
an encryption/decryption unit, using said encryption/decryption key for decrypting encrypted input information received by said memory encryption/decryption apparatus and encrypting output information of said memory module.

2. The memory encryption/decryption apparatus of claim 1, wherein said encrypted input information includes the memory addresses of a write command of said memory module, a writing data, a read command of said memory module and a reading data.

3. The memory encryption/decryption apparatus of claim 1, wherein said output information is a read data of said memory module.

4. The memory encryption/decryption apparatus of claim 1, wherein said memory module is an electrically erasable programmable read only memory (EEPROM) or a flash memory.

5. A memory encryption/decryption system, comprising:
a memory module;
an external device;
an encryption/decryption key;
a first encryption/decryption unit, installed at said external device, for encrypting input information sent from said external device to said memory module by using said encryption/decryption key to produce encrypted input information, and decrypting said encrypted output information sent from said memory module to said external device to produce output information; and
a second encryption/decryption unit, installed at said memory module, for encrypting said output information sent from said memory module to said external device by using said encryption/decryption key to produce encrypted output information, and decrypting said encrypted input information sent from said external device to said memory module to produce said input information;
wherein said input information and output information are stored in said memory module.

6. The memory encryption/decryption system of claim 5, wherein said input information include the memory addresses of a write command of said memory module, a writing data, a read command of said memory module, and a reading data.

7. The memory encryption/decryption system of claim 5, wherein said output information is a read data of said memory module.

8. The memory encryption/decryption system of claim 5, wherein said memory module is an electrically erasable programmable read only memory or a flash memory.

9. A memory encryption/decryption method, comprising:
providing an encryption/decryption key;
providing a memory module; and
installing an encryption/decryption unit at said memory module;
decrypting said encrypted input information by using said encryption/decryption unit and said encryption/decryption key, if said memory module receives encrypted input information; and
encrypting output information by using said encryption/decryption unit and said encryption/decryption key to produce encrypted output information and send said encrypted output information to said remote end, if said memory module sends output information to a remote end.

10. The memory encryption/decryption method of claim 9, wherein said input data include the memory addresses of a write command of said memory module, a writing data, a read command of said memory module and a reading data.

11. The memory encryption/decryption method of claim 9, wherein said output information is a read data of said memory module.

12. The memory encryption/decryption method of claim 9, wherein said memory module is an electrically erasable programmable read only memory or a flash memory.
